(19) United States
(12) Patent Application Publication
(10) Pub. No.: US 2012/0036955 A1
(43) Pub. Date: Feb. 16, 2012

(54) Involute gear

(76) Inventor: Michael Gogola, South Bend, IN (US)

(21) Appl. No.: 12/806,304

(22) Filed: Aug. 10, 2010

(51) Int. Cl. F16H 55/08

(52) U.S. Cl. 74/462

(57) ABSTRACT

A gear for driving a linear member comprising a tooth tip, a tooth base, a contact face disposed between the tooth tip and the tooth base, the contact face having the shape, X=L sin(α−Θ) and Y=L cos(α−Θ), where tan(α)=(B/2+2πΘ/360) /R, L=(R\hat{0}2+(B/2+2πΘ/360/R)\hat{0}2)\hat{0}0.5, B=width of tooth base, R=pitch radius, Θ=relative angle of gear tooth to contacting member, a linear member comprising a plurality of holes, and the contact face engagable with the linear member through a hole.

### FIELD OF THE INVENTION

The invention relates to an involute gear, and more particularly, to an involute gear having a contact surface for engaging a linear rack.

### BACKGROUND OF THE INVENTION

Trailer slide out rooms are actuated by use of a wide variety of power transmission systems, typically referred to as a slide-out system. The slide out system provides the power to push the room in and out, as well as help support the room in the out position.

One of the main requirements of any slide out system is that the slide out must move the room in a quiet and smooth manner. Any excessive noise or jarring motions are undesirable to the customer. Smooth, quiet power transmission is typically achieved in slide out systems through use of a traditional rack and pinion system.

Typical systems include a “through the frame” slide system. The inner slide tube pushes the room out and supports the weight of the room. A precision machined rack is welded to the slide tube and meshes with a pinion gear. The rails push the room out and support the weight of the room. A gear meshed with the rail. Rotation of the gear moves the rail back and forth.

Representative of the art is U.S. Pat. No. 6,964,210 which discloses a gear and method for producing the gear. The gear has a gear tooth profile conjugate to a gear basic-cutter tooth-profile having an addendum with a convex portion having an addendum point proximal to a pitch line and a dedendum with a concave portion having a dedendum point proximal to the pitch line. The convex portion is complementary with a corresponding portion of a mating-gear basic-cutter tooth-profile dedendum. The concave portion is complementary with a corresponding portion of the mating-gear basic-cutter tooth-profile addendum. A transition zone between the addendum point and the dedendum point has a predetermined width. The gear basic-cutter tooth-profile has a predetermined half pitch relief at the pitch line and continuity of profile and continuity of slope at the addendum point.

What is needed is an involute gear having a contact surface for engaging a linear slide tube. The present invention meets this need.

### SUMMARY OF THE INVENTION

The primary aspect of the invention is to provide an involute gear having an arcuate contact surface for engaging a linear slide tube.

Other aspects of the invention will be pointed out or made obvious by the following description of the invention and the accompanying drawings.

The invention comprises a gear for driving a linear member comprising a tooth tip, a tooth base, a contact face disposed between the tooth tip and the tooth base, the contact face having the shape, X32 L sin(α−Θ) and Y=L cos(α−Θ), where tan(α)=(B/2+2πΘ/360)/R, L=(R\hat{0}2+(B/2+2πΘ/360/R)\hat{0}2)\hat{0}0.5, B=width of tooth base, R=pitch radius, Θ=relative angle of gear tooth to contacting member, a linear member comprising a plurality of holes, and the contact face engagable with the linear member through a hole.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a perspective view of a slide tube.

FIG. 2 is a side view of the inventive tooth profile.

FIG. 3 is an elevation end view of a gear engaged with a slide tube.

FIG. 4 is an elevation side view of a gear engaged with a slide tube.

FIG. 5 is an elevation side view of a gear tooth.

FIG. 6 is an elevation side view of a gear tooth alternate embodiment.

### DETAILED DESCRIPTION OF THE PREFERRED EMBODIMENT

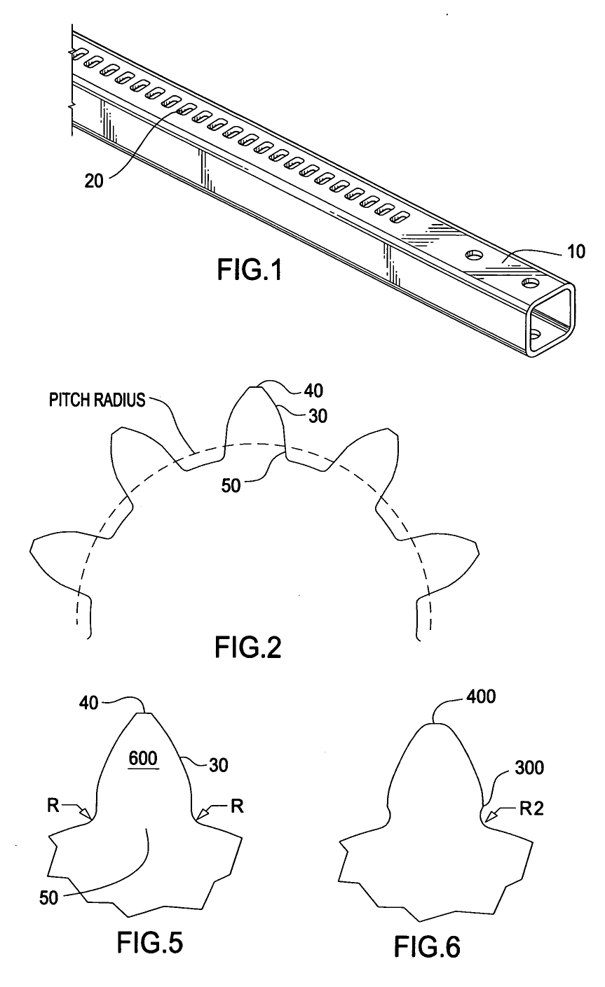

FIG. 1 is a perspective view of a slide tube. The invention comprises an involute gear tooth design that can interface with a pattern of holes in a slide tube. The linear form of the slide tube results in what also can be called a linear rack member.

FIG. 1 shows a plurality of stamped holes 20 in a slide tube member 10. Member 10 has a linear form and is for use as a slide rail in a ‘through the frame’ slide out system on a recreational vehicle or trailer.

Member 10 is typically fabricated from tubes having a square cross-section. As such, a prior art pinion gear shape does not efficiently and smoothly mesh with the shallow, straight walled holes 20. Therefore, a new gear tooth shape is required to mesh with the slide tube holes.

FIG. 2 is a side view of the inventive tooth profile. The proposed gear tooth 600 has three regions: (1) the contact face 30 of the tooth, (2) the base 50 of the tooth, and (3) the tooth tip 40.

Contact face 30 provides the means by which power is transmission from the gear, thereby urging member 10 to provide smooth linear motion. Proper operation of the gear and slide tube 10 is determined by the shape of the contact face 30. The inventive form of the contact face is designed to accommodate proper engagement with holes in a slide tube 10.

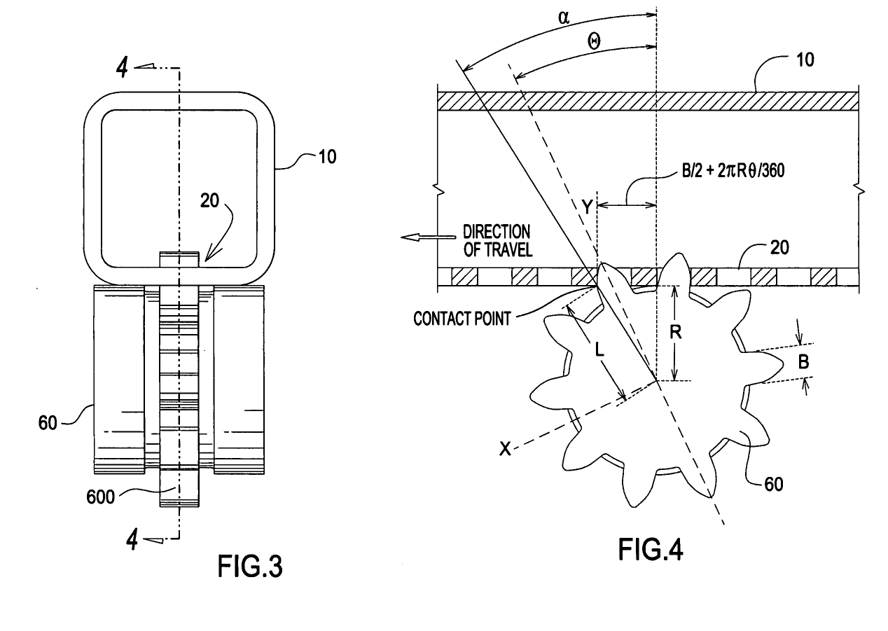

FIG. 3 is an elevation end view of a gear engaged with a slide tube. Slide tube 10 comprises a plurality of holes 20.

FIG. 4 is an elevation side view of a gear engaged with a slide tube. The equations and variables that govern the shape of the tooth contact face 30 are as follows:

X=L sin(α−Θ)

Y=L cos(α−Θ)

Where;

tan(α)=(B/2+2πΘ/360)/R

L=(R̂2+(B/2+2πΘ/360/R)̂2)̂0.5

B=Width of tooth base

R=Pitch radius

Θ=Relative angle of gear tooth to contacting member.

In the special case of the slide tube 10 driving the rotary motion of the gear 60, the contact face will extend to Θ<0. The limit of the contact face 30 will be when

L=R, or α=0

This occurs when

Θ=(B/2R)*(360/n)

The tooth base 50 is the region located underneath the pitch radius (FIG. 2) and contact face 30. The purpose of the tooth base is to provide a space for a radius R at the root of the tooth. The radius R is required for stress and strength requirements.

In the special case of the slide tube 10 driving the rotary motion of the gear 60, the base of the tooth must be somewhat undercut to avoid interference (see FIG. 6).

The tip of the tooth 40, is limited by the overall arc of tooth engagement between contact face 30 and slide tube member 10.

In the special case of the slide tube 10 driving the rotary motion of the gear 60, the tip of the tooth may be rounded off to avoid interference, see FIG. 6.

Member 10 is box shaped in cross-section, however, the lower portion of member 10 which includes holes 20 is substantially linear with a plurality of holes arranged in a linear order.

FIG. 5 is an elevation side view of a gear tooth.

FIG. 6 is an elevation side view of a gear tooth alternate embodiment. In the alternate embodiment the tooth tip 400 is rounded to avoid interference with the member 10. A tooth base undercut R2 results form an extended tooth contact face 300. The extended tooth contact face 300 lengthens the interval for which the tooth engages the member 10, which has the effect of further smoothing operation of the system.

Although a form of the invention has been described herein, it will be obvious to those skilled in the art that variations may be made in the construction and relation of parts and method without departing from the spirit and scope of the invention described herein.

I claim:

1. A gear for driving a linear member comprising:
a tooth tip;
a tooth base;
a contact face disposed between the tooth tip and the tooth base, the contact face having the shape,
X=L sin(α−Θ) and Y=L cos(α−Θ), where
tan(α)=(B/2+2πΘ/360)/R,
L=(R\hat{0}2+(B/2+2πΘ/360/R)\hat{0}2)\hat{0}0.5,
B=width of tooth base,
R=pitch radius,
Θ=relative angle of gear tooth to contacting member;
a linear member comprising a plurality of holes; and
the contact face engagable with the linear member through a hole.

2. The gear as in claim 1, wherein the linear member has a rack form.

3. The gear as in claim 1, wherein the tooth tip is arcuate.

4. The gear as in claim 1, wherein the tooth base comprises a radius (R).
